(19) United States
(12) Patent Application Publication
(10) Pub. No.: US 2005/0207150 A1
(43) Pub. Date: Sep. 22, 2005

(54) Gathering decoration of light bulb assemblies

(76) Inventor: Hung-Huei Cheng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/801,707

(22) Filed: Mar. 17, 2004

(51) Int. Cl. F21S 2/00; F21S 13/14; F21S 4/00

(52) U.S. Cl. 362/227; 362/806

(57) ABSTRACT

The invention relates to a gathering decoration of bulb assemblies, which includes a branchy frame and a light string with different bulb assemblies. The frame connects with flower-type bulb assemblies gathered on top of its truck and connects with miniature bulb assemblies on other position to form a lighting decoration as a flower. The lighting flower displays a special decorative effect having beauty and utility.

### FIELD OF THE INVENTION

The present invention relates to a gathering decoration of light bulb assemblies, which includes several bulb assemblies with flower-type bulb holders being provided together to display a special decorative effect.

### BACKGROUND OF TEE INVENTION

It is known that a decorative light string provides only lighting effect, which includes many bulb assemblies with the same structure, such as miniature bulb assemblies. This conventional light string has no variety that the decorative effect will be poor. The light string is usually used by hanging on another support to show the lighting effect, which is still monologue.

### SUMMARY OF THE INVENTION

The present invention is to provide a gathering decoration of light bulb assemblies, which has different bulb assemblies with flower-type holder to be mounted together. Hence, it can display a special outlook as a lighting flower to improved utility. Now, accompanying with the following drawings, the character of the present invention will be described here and after.

### BRIEF DESCRIPTION OF THE DRAWINGS

FIG. 1 is a perspective view showing a gathering decoration of bulb assemblies according to the present invention.

### DETAILED DESCRIPTION OF THE PREFERRED EMBODIMENT

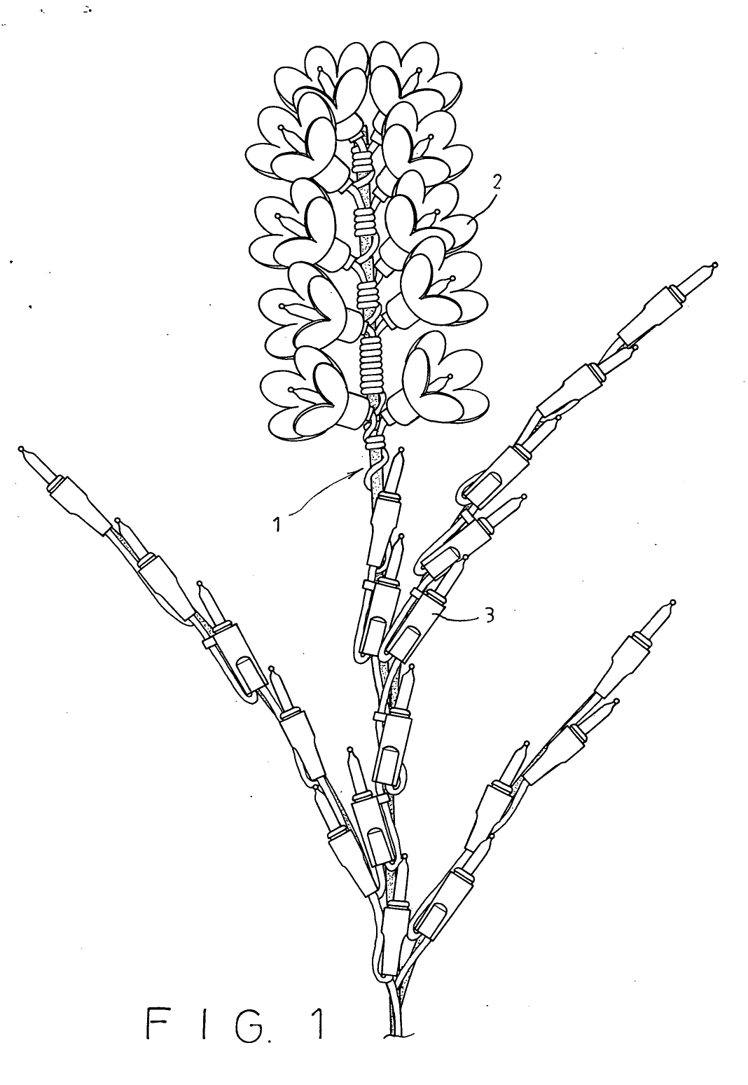

Referring to FIG. 1, the present invention is to provide a gathering decoration of bulb assemblies, which includes a branchy frame (1) and a light string having two kinds of bulb assemblies, one of which is flower bulb assembly (2) with flower-type bulb holder and another is conventional miniature bulb assembly (3). The flower bulb assemblies (2) are provided around top of trunk of the frame (1) while the miniature bulb assemblies (3) are provided around other branches of the frame (1). Under such connection, the frame (1) with the flower bulb assemblies (2) can be displayed as a real lighting flower. The gathering flower bulb assemblies (2) seem to be the flower and the miniature bulb assemblies (3) will be leaves.

When all the bulbs are lightened, the frame (1) will show a lighting flower that provides a novel and special decoration effect with great improvement. On the other hand, the above embodiment is only an exemplary of the present invention. Any other modification can be made, such as change of the shape of bulb holder or variety of the frame, those of which are also claimed in this application that possesses the gathering bulb assemblies to display the specific decorative purpose.

1. A gathering decoration of bulb assemblies including a branchy frame and a light string with many bulb assemblies, wherein the bulb assemblies has two kinds, one of which is flower bulb assembly with flower-type holder and another is miniature bulb assembly; the flower bulb assemblies being gathering on top of trunk of the frame while the miniature bulb assemblies being provided around other branches of the frame to form a lighting flower.

2. A gather decoration of bulb assemblies including a light string with several bulb assemblies having the same configuration for gathering on a decorative frame at a same position.
